(19) United States
(12) Patent Application Publication
(10) Pub. No.: US 2014/0223804 A1
(43) Pub. Date: Aug. 14, 2014

(54) DEVICE FOR REMOTE INSECT CAPTURE AND DISPOSAL

(71) Applicant: Troy A. Cornman, SR., Leechburg, PA (US)

(72) Inventor: Troy A. Cornman, SR., Leechburg, PA (US)

(21) Appl. No.: 14/148,638

(22) Filed: Jan. 6, 2014

Related U.S. Application Data
(60) Provisional application No. 61/749,057, filed on Jan. 4, 2013.

(51) Int. Cl. A01M 3/04

(52) U.S. Cl. CPC A01M 3/04
USPC 43/114

(57) ABSTRACT

A device for capturing live or dead insects on a surface that can be disposed of without direct user contact while the insect is covered from view. The device includes an extensible handle and swivel base/connector to which would be temporarily affixed a disposable cap having an outer rim/perimeter and flexible central surface to which adhesive is affixed or applied. Preferably, the swivel base/connector is lighted and each cap includes a central aperture through which light can pass.

### CROSS-REFERENCE TO RELATED APPLICATION

This is a perfection of U.S. provisional application Ser. No. 61/749,057, filed on Jan. 4, 2013, the disclosure of which is fully incorporated by reference herein.

### BACKGROUND OF THE INVENTION

1. Field of the Invention

The present invention relates to a device for removing crawling insects, and flying insects which have temporarily landed, as well as the remains of dead insects. This invention hygienically disposes of an insect without its operator having to ever touch bug and any sticky surface to which it is adhered. Preferably, this invention is provided with lighted means for assisting with proper positioning over an otherwise hard-to-reach target.

It is known in the art to provide adhesive means for engaging an insect with an adhesive sheet and then disposing of the capture while still attached. Many people become easily repulsed by insects like roaches, stink bugs and spiders. They find that getting close to a bug, even when enveloped in adhesive sheet, to be quite unnerving.

2. Relevant References

There are many known devices for bug entrapment but none having all the combined features/advantages of this invention. Representative devices include, in chronological order, the molasses filled cup ring of Anderson U.S. Pat. No. 229,230; the flat, paper holding insect catcher of Walker U.S. Pat. No. 1,102,829; the recessed panel on a swivel neck from Hemenway U.S. Pat. No. 1,154,310; and the adjustable swatter from Kelly U.S. Pat. No. 1,174,733.

In addition, there is a second, improvement to fly catchers from Hemenway U.S. Pat. No. 1,190,165; the screened flycatcher of Northcott U.S. Pat. No. 1,311,704; and the more recent bug “blotter” of Lynn U.S. Pat. No. 6,044,584. A clapping insect captivator is the subject of Vierra U.S. Pat. No. 7,065,919; and a permanently angled, reuseable handled device is disclosed in Young U.S. Published Application No. 2008/0040967. A complicated, insect capturing device, with similar intentions to the present invention, is shown and described in Blum U.S. Pat. No. 7,469,501.

### SUMMARY OF THE INVENTION

It is an object of the invention to provide a system/device for capturing live or dead insects inside one's house and disposing of such insects while the user's hands remain remote from potential insect contact. It is another object that applicant's device cover the insect from view of the user to avoid disturbing the same during retrieval and disposal.

This device is armed with single use, disposable caps, each having an adhesive sheet interior on a recessed surround/perimeter. These caps are held by a swivel connector (preferably magnetic) that rigidly attaches to a telescopic handle for reaching insects higher on an interior wall or along a room's ceiling. More preferably, the head to applicant's swivel connector includes a directional light, and his respective caps an aperture through which the device's light will pass, if needed. The swivel connector disconnects from a “used” disposable cap by manually moving a connector collar towards the cap once it is properly situated over a trash receptacle. Optionally, the telescopic handle may include a trigger release that, when activated, will mechanically (or magnetically) release a used cap for disposal. All of the foregoing may be stored together, along with additional, replacement caps, in an inconspicuous, out-of-view, device holder/container.

In the operation of this invention, one first installs a cap over the swivel connector head and extends the handle's telescopic arm to a needed/preferred overall length. The cap is then centered over the bug (live or dead) to be removed, using the centering positioning light/lamp, if needed. For most insects, mere positioning of the cap there over will cause the capture to adhere to the cap's underside. For very small insects, it may be necessary to push in and towards the wall/ceiling thereby causing the slight flexibility of one's disposable cap to bevel inwardly and assure bug capture thereon.

Once it has been visually confirmed that a bug has been captured, the device can be positioned over a trash can and its cap physically removed therefrom (typically by manual magnetic release and/or by activating a handle trigger for cap disconnecting. In a preferred instance, the trigger handle merely demagnetizes the capture end so that the USED cap falls safely in the trash. A replacement (clean) cap can be installed over the device's swivel connector end and the whole combination safely stored away ready for the next (unexpected) bug removal need.

These and other objects, features, and advantages of the invention will become more apparent from the detailed description of an exemplary embodiment thereof as illustrated in the accompanying drawings, in which like elements are designated by like reference characters in the various figures.

### BRIEF DESCRIPTION OF THE DRAWINGS

Further features, objectives and advantages will become clearer with the following detailed description made with reference to the accompanying drawings in which:

FIG. 1 is a top perspective view of the device in a system/container with the handle of the device extending upwardly and outwardly therefrom;

FIG. 2 is a sectional view taken along lines II-II of FIG. 1;

FIG. 3 is a side view of the device without a bug removal cap situated (or connected) to its base for illustration purposes;

FIG. 4 is a side view focusing on one embodiment of lighted swivel connector for the device of this invention;

FIG. 5 is a sectional view taken along lines V-V of FIG. 4;

FIG. 5A is a sectional view of an alternate embodiment of swivel connector without any central light source;

FIG. 6 is a bottom perspective view of a preferred swivel connector pivotally secured to one handle end with a representative dual ball joint connection;

FIG. 7 is a top plan view of one embodiment of bug cap having a lighted central aperture;

FIG. 8 is a bottom plan view of the bug cap from FIG. 7; and

FIG. 9 is a sectional view taken along lines IX-IX of FIG. 8.

### DETAILED DESCRIPTION OF PREFERRED EMBODIMENTS

Referring now to the drawings, there is shown several embodiments of device, system and disposable caps for use according to the invention. In the accompanying drawings, common elements are commonly numbered in the respective views. For the alternative embodiment, common elements are consistently numbered though in the next hundred series.

In FIGS. 1 and 2, the system (generally 10), comprises an outer cuplike container 12 having curved sidewalls 14 and a base 16 with a central aperture 18 at its top. For illustration purposes, a rotatable lid 20 that is affixed at one end 22 and lockable to open or close at the opposite end 24 has a cutaway slit 26 through which the main device may extended, stored but loaded for immediate use upon extraction from container 12. Ideally, that container 12 can “store” the device with a bug cap affixed and ready to go while still hiding most of the device in an inconspicuous, possibly even aesthetically pleasing manner.

On a preferred basis, container 12 can also store additional replacement caps (described in greater detail below). In cutaway side view FIG. 2, three such replacement caps 30a, b and c are stored in the base 16 or container bottom beneath a “loaded”, i.e. cap-positioned device, generally 40. Alternately, there can be situated a cap storage sleeve (not shown) either beneath the main container body or in which that main body will rest, with a plurality of replacement caps stored therein. In the latter arrangement, the main body can be lifted and resituated in a new cap storage sleeve when the original sleeve's allotment of replacement caps has been exhausted.

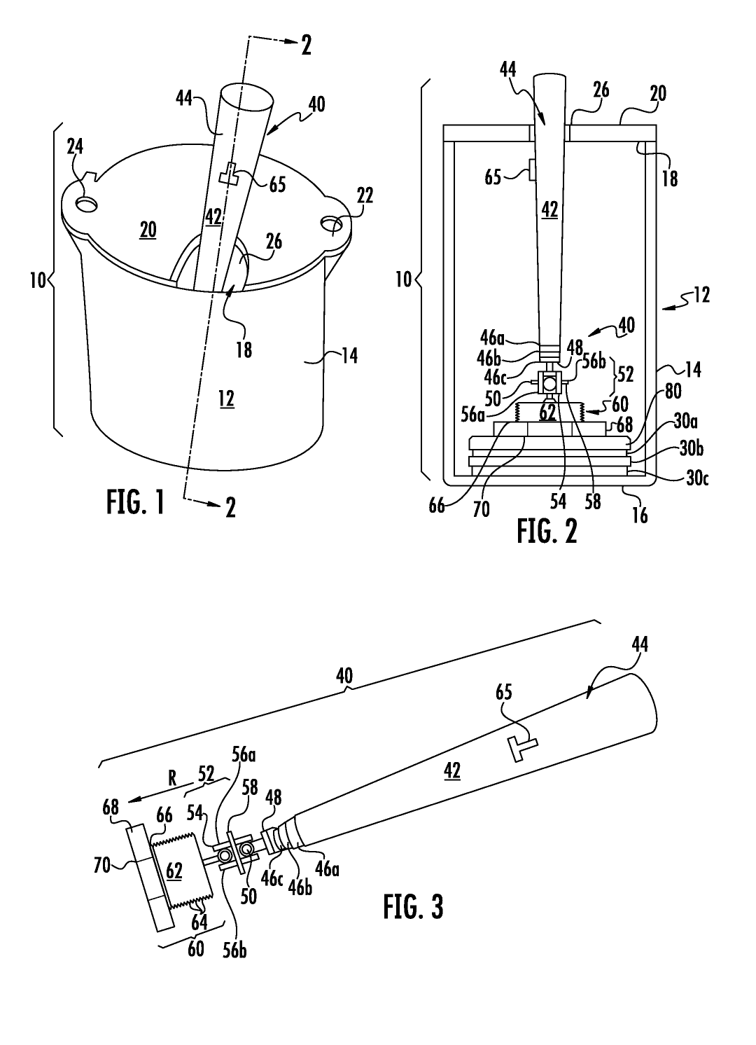

Referring now to FIG. 3, there is shown a first embodiment of device 40 comprised of its several main components. They include main handle 42 with a comfortable grip 44, possibly rubberized for better holding and easy cleaning As shown fully retracted within the confines of handle 42 are multiple sections of telescopic extensions 46a, b and c. They will allow device 40 to extend from something less than 12 inches in total length to extended lengths of up to 3 feet/36 inches or more.

At the base end 48 to the last extension 46c of device 40, there is included a ball 50 as part of a dual ball joint connection 52. It matches a corresponding ball 54 atop the main swivel base/connector component, generally 60. As seen in FIGS. 2, 3 and 6, the two ball components 50 and 54 of joint connection 52 are joined by opposing side shields 56a and b held firmly together with a threaded pin 58 that extends through both side shields 56a and b. Such an arrangement allows device 40 to firmly adjust to pivoted angles for better reaching insects high on a side wall or along a ceiling, above the user's head. It should be understood, however, that this pivoting connector is but one mechanical means for joining handle to swivel connector. Other possible variations may be substituted therefor.

As shown in FIGS. 1 and 3, one embodiment of handle 42 of this invention includes an optional trigger 65. With more sophisticated models, device 40 can be triggered to separate a “used” bug cap from swivel base 60 when duly situated over a trash receptacle. For one preferred magnetic connection, that may mean triggering handle 42 to demagnetize thereby separating the used cap from the device proper. For other more mechanical connection variations, like an alternative hook and latch connection (not shown), its trigger may “unlock” the hook thereby freeing the used (bug containing) cap and its latched top to fall into a trash receptacle.

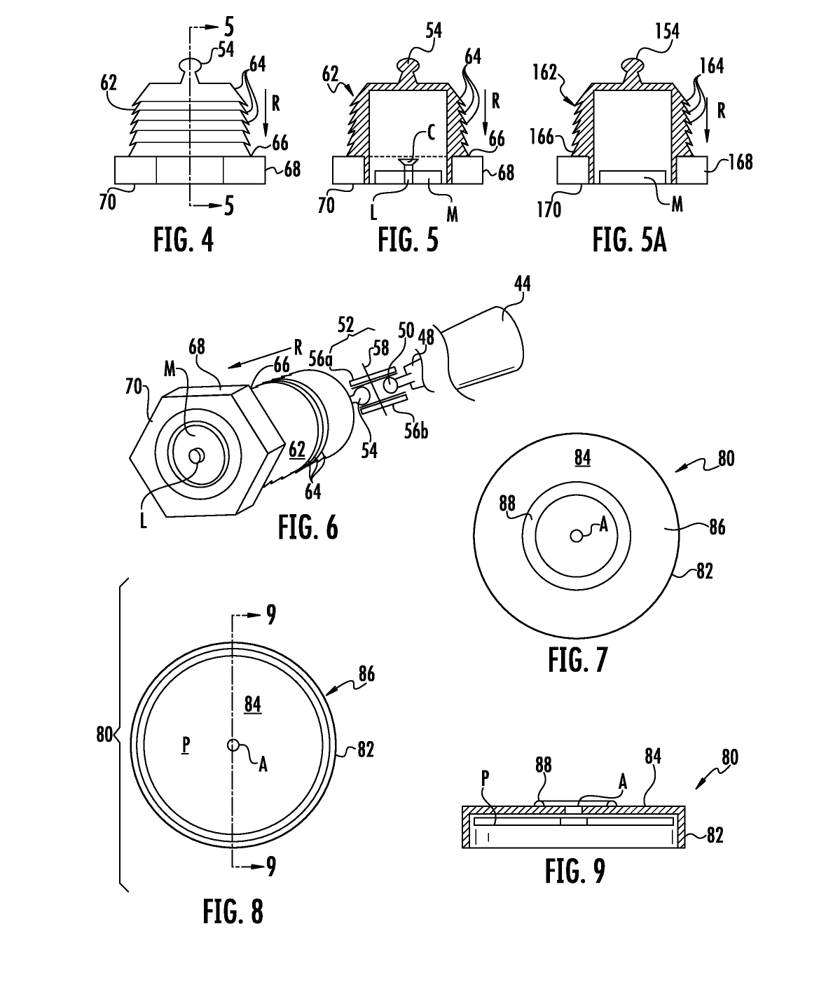

FIGS. 4 and 5 show one preferred embodiment of swivel base/connector 60 according to this invention. It includes a top joint, in this case, with balled tip 54 that extends down and through a cylindrical case 62. Preferably, that case has external ridges 64 that can assist a user/operator with manually moving base/connector 60 in the direction of release arrow R in order to “chuck” the used bug cap from said base and into the trash.

At the bottom 66 of base/connector 60, there is shown a hexagonally-shaped surround 68 to magnetic extension M though it is to be understood that other base shapes/configurations may also suffice. When in use, the substantially flat end 70 to magnetic extension M will protrude at least partially outwardly from its swivel connector. There, it will temporarily attach/detachably connect to a disposable bug cap, generally 80, described later herein.

In the preferred embodiment of FIGS. 4, 5 and 6, there is also shown a light L, powered by battery cell C internal to the swivel base/connector 60. That light is meant to shine/project through a preset central aperture A in the bug caps 80 for assisting with better situating/placement over the target insect to be removed and disposed of. In this preferred embodiment, light L turns on and off by a twist or slight rotation of base/connector 60. Alternately, a light switch (not shown) may be added that might require electronics passing through handle 42 to operate.

In FIG. 5A, an alternate version of swivel base/connector 160 is shown in cross-section. It does not contain a light and power cell therefor. Accordingly, it should be easier to manufacture and retail for less.

FIGS. 7 through 9 show one preferred embodiment of bug cap 80 for use with the preferred embodiment of lighted swivel base/connector (element 60 in FIGS. 4, 5 and 6). Note that cap 80 is essentially round (though other cap shapes will also suffice) with a protruding perimeter 82 for “cupping” over/about the targeted bug and a flexible center section 84 with its substantially flat top exterior 86. It does not necessarily have to fit flush against a wall, ceiling or other flat surface during operation of the device for bug retrieval/removal. Preferably, the center section 84 has some flexibility so as to be able to bevel inward, towards the wall or ceiling, if needed to better capture/affix the insect-bug to the cap proper. In that regard, center section 84 can be made from aluminum, steel or another metal. Or alternately, center section 84 is a substantially plastic disk with a plastic (or metal) surrounding perimeter 82.

A central aperture A in that cap provides means for light from the swivel connect to pass through and project over the bug. This is especially useful when trying to catch and extract certain insects from behind couches and/or other furniture.

The exterior 86 to cap 80 includes a centering ridge 88 or other raised protrusion for receiving the magnetic end M to swivel base/connector 60. In one version, a simple rubber washer can serve as the centering ridge 88 though it is to be understood that other configurations may be substituted therefor.

In at least one alternate embodiment, a hook and latch connector may replace the foregoing arrangement of cap centering ridge and circular-shaped magnetic end. Should a different shaped magnetic head be used, the corresponding cap ridge may be “customized” to synchronize more closely. Of course, if the device has no lighted bottom, there would be no need to provide apertures to all models of replacement caps for use with this invention.

In the accompanying FIGS. 7 through 9, there is included a section of adhesive/sticky paper P in the interior to flexible center portion 84. As shown, it is also circular in shape though disposable caps can be fitted with other shapes of sticky paper as well. In any event, these sheets are pre-fitted and already adhered to the throw away caps used with this device so there is no need to worry about centering replacement sheets onto a single cap element that would otherwise be made “reuseable”. Alternately, a sticky adhesive material may be applied directly to the interior flexible center portion 84 of each cap 80.

It is a principal object of this invention for a user/operator to not have to touch (or otherwise contact) a “used” cap (i.e., a cap with one or more bugs captured/affixed) for disposal and eventual device reloading. Since there is no need to affix replacement sticky sheets, the cap sheets will be “pre-centered” and have their central aperture duly aligned with the aperture through the cap top for the swivel connector's lighted base to shine through.

While I have shown and described preferred embodiments, it will be understood that the invention may be embodied otherwise than as specifically illustrated or described, and that certain changes in form and arrangement of parts may be made within the underlying idea or principles of the invention.

What is claimed is:

1. A device for remotely capturing an insect on a surface that can be disposed of without requiring direct contact with the insect, said device comprising:
a handle portion;
a swivel base connected to one end of the handle portion, said base having means for temporarily connecting to a disposable cap, said disposable cap having a raised perimeter about a flexible central region to which is attached or applied an adhesive.

2. The device of claim 1, which further includes a trigger for mechanically releasing the disposable cap from the swivel base.

3. The device of claim 1, which further includes a trigger for magnetically releasing the disposable cap from the swivel base.

4. The device of claim 1 wherein the swivel base includes a lighted tip and the disposable cap has an aperture through which light from the swivel base may pass.

5. The device of claim 4 wherein the lighted tip and the disposable cap aperture are centrally located.

6. The device of claim 1 wherein the handle portion includes a plurality of telescopic extensions.

7. The device of claim 1, which can be stored in a cuplike container with the disposable cap attached for immediate use upon removal from the container.

8. The device of claim 7 wherein the container includes a compartment for storing a plurality of replacement disposable caps.

9. The device of claim 1 wherein the flexible central region allows for some beveling to engage an insect if needed.

10. The device of claim 9 wherein the flexible central region is made from metal.

11. The device of claim 9 wherein the flexible central region is made from plastic.

12. A system for indoor capturing of insects on a sticky cap that can be ejected without user contact for disposal, said system comprising:
a container for storing a device comprising: a handle portion; and a swivel base connected to one end of the handle portion, said base having means for temporarily holding a sticky cap with a raised perimeter and a flexible central region to which adhesive is affixed or applied; and
a compartment for storing a plurality of replacement sticky caps.

13. The system of claim 12 wherein the device further includes a trigger for mechanically releasing the sticky cap from the swivel base.

14. The system of claim 12 wherein the device further includes a trigger for magnetically releasing the sticky cap from the swivel base.

15. The system of claim 12 wherein the swivel base includes a lighted tip and the sticky cap has an aperture through which light from the swivel base may pass.

16. The system of claim 12 wherein the handle portion of the device includes a plurality of telescopic extensions.

17. The system of claim 12 wherein the flexible central region of the sticky cap is made from metal, plastic or combinations thereof.

18. A disposable cap for indoor capturing an insect, said cap comprising a raised perimeter and a flexible central region to which adhesive is affixed or applied, said cap adapted for temporarily connecting to a device with a telescopic handle and a swivel base.

19. The disposable cap of claim 18, which is adapted to mechanically or magnetically attach to and detach from the swivel base of the device.

20. The disposable cap of claim 18 wherein the flexible central region is made from metal, plastic or combinations thereof.
